(19) United States
(12) Patent Application Publication
(10) Pub. No.: US 2012/0078923 A1
(43) Pub. Date: Mar. 29, 2012

(54) SCRIPTING USING NEW ORDERING ALGORITHM

(75) Inventors: Manish Kumar Jain, Andhra Pradesh (IN); Arpita Gupta, Andhra Pradesh (IN); Alok Kumar Parmesh, Andhra Pradesh (IN)

(73) Assignee: Microsoft Corporation, Redmond, WA (US)

(21) Appl. No.: 12/893,490

(22) Filed: Sep. 29, 2010

(51) Int. Cl. G06F 17/30

(52) U.S. Cl. 707/752; 707/E17.055

(57) ABSTRACT

Ordering data objects. The method includes, for each object to be ordered into a set of ordered objects, determining whether the object has static dependencies or dynamic dependencies. A dynamic object is an object that may have circular dependencies. For each static object with only static dependencies, the objects are ordered according to a pre-determined type order. The method further includes, for one or more dynamic objects with dynamic possibly circular dependencies, resolving the circular dependencies such that the dynamic objects can be ordered with the static objects.

### BACKGROUND

### Background and Relevant Art

Computers and computing systems have affected nearly every aspect of modern living. Computers are generally involved in work, recreation, healthcare, transportation, entertainment, household management, etc.

System data may need to be migrated. For example, data in a database may be need to be moved from one server to another server. Previously, this required ordering data objects in a graph or ordered list using an order method that was very complicated and was done using a cumbersome T-SQL query to find dependent objects, then traversing the graph returned by the query, breaking cyclic dependencies and coming up with an ordered list of the objects. This was neither performing nor scaling up well.

SQL Server Objects have dependencies and sometimes circular dependencies. For example, a Table data type can depend on a user defined data type for its column's data type or on a User Defined Function for a computed column. View data type can depend on a Table data type in its definition. Similarly, a stored procedure data type or a user defined function can depend on a Table data type in their definitions. In some situations this can result in cyclic dependencies where data types are dependent on (either directly or indirectly) data types that themselves are dependant the data types.

Dependencies can generally be categorized in two categories. The first category is hard dependencies in which objects cannot be created unless the object it is depending on has been created. The second category is soft dependencies, or those in which objects can be created even if object it is depending on (i.e. referencing) is not present.

Presently, to migrate or copy a database without physical structure like database files or backups, one uses T-SQL scripts. For a T-SQL script to work it needs to ensure that in a script while creating an object all its dependencies which are hard dependencies have been created by the script above.

One of the solutions of this problem which was employed previously, was to construct a forest with various objects as node like structures and to break the cyclic dependencies by removing the soft dependencies and then doing a topographical sorting for remaining nodes to get the list.

The above explained algorithm had limitations. For example, when there are a large number of objects it can take a significant amount of time to construct graphs by using are large number of T-SQL queries. Breaking cycles and constructing list was also expensive. Further, in some situations, this method did not cover all the SQL Server Objects.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method that may be practiced in a computing environment. The method includes acts for ordering data objects. The method includes, for each object to be ordered into a set of ordered objects, determining whether the object has static dependencies or dynamic dependencies. A dynamic object is an object that may have circular dependencies. For each static object with only static dependencies, the objects are ordered according to a pre-determined type order. The method further includes, for one or more dynamic objects with dynamic possibly circular dependencies, resolving the circular dependencies such that the dynamic objects can be ordered with the static objects.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates an object map including objects with dynamic circular dependencies;

FIG. 1B illustrates an ordered graph for the object map; and

FIG. 2 illustrates a method of ordering objects.

### DETAILED DESCRIPTION

In some embodiments described herein, ordering algorithms may be based on the fact that many of the types in T-SQL relational domain have static dependencies on each other and thus can be placed in a static list on the basis of their types without the need to find dependencies between them by running a number of queries to determine the dependencies. For any remaining objects which can have cyclic dependencies a limited number of queries may be used or a T-SQL parser may be used. Thus, embodiments may reduce the number of expensive T-SQL queries by determining static dependencies that can be determined without running T-SQL queries.

Thus, embodiments may implement a mixed use of static relational ordering and the run time ordering using T-SQL queries or a parser. Using a parser may be used to provide complete offline solution.

New ordering methods may be implemented based on the fact that many of the types in relational domains have static dependencies on each other and thus can be placed in a static list on the basis of their types without the need to find the dependencies between them using queries or parsers. For the remaining objects which can have cyclic dependencies embodiments may either query an engine or use a parser for resolving the dependencies and cycles. For example, for the remaining queries, algorithms such as those shown in U.S. Pat. No. 7,136,868 titled “Database Object Script Generation Method and System” issued on Nov. 14, 2006 may be used.

Some examples of static types include: Assembly, Data Types, Stored Procedures, and Triggers. Further, it is known that Assembly will always be at the beginning of a graph because all types depend from an Assembly type and that Triggers are always as the end of a graph, because no types depend from Triggers. Further, Stored Procedures will be placed before Data Types in the graph, because Data Types always depend from Stored Procedures.

Examples of dynamic types include Table, View (which is dependent on Table), User Defined Functions (UDF) and Users.

Further, as will be illustrated in the examples below, some dynamic types can be broken down in a way that allows them to be, at least partially, represented in a graph as a static type.

Analysis of the dependencies of various SQL Server object types on each other shows that many of the object types have straight dependencies; i.e. they depended on one or more object types and one or more object types depended on them, and even if operations were performed to recursively go about finding dependencies they would not form a cycle. However, there are a few exceptions to this rule that are addressed in various ways.

One group of objects which had cyclic dependencies is Database and server security objects.

For example, consider the following two server security objects:

CREATE ROLE [role2] AUTHORIZATION [role1]
CREATE ROLE [role1] AUTHORIZATION [role2]

As can be observed, these two objects are dependent on each other in a cyclic manner. Embodiments may split them into multiple parts to avoid constructing graphs and finding dependencies using as shown below:

CREATE ROLE [role2]
CREATE ROLE [role1]
ALTER AUTHORIZATION ON ROLE::[role1] TO [role2]
ALTER AUTHORIZATION ON ROLE::[role2] TO [role1]

The following is the execution ordered static list of the SQL Server objects based on the types of object. As illustrated below and annotated by *, there are three dynamic groups: Server Security Objects, Database Security Objects, and Table, View, and User Defined Functions (UDF). These discussed separately herein.

1. Unresolved Entities

2. Server Settings

3. OLEDB Provider Settings

4. User Options

5. File stream Settings

6. Full Text Service

7. Cryptographic Provider

8. Credential

9. Database

10. Server Security Objects*
Login
Master Database Assembly
Master Database Certificate
Master Asymmetric key
Certificate or Asymmetric key based login
Server Role
Server Security Objects' permissions
Server Security Objects' memberships
Server Security Objects' ownership

11. Linked Server

12. Audit

13. User defined message

14. Http endpoint

15. Endpoint

16. Database encryption

17. Database master key

18. Application role

19. Database Security Objects *
User
Database assemblies with dependencies
Database certificates
Database asymmetric key
Certificate or asymmetric key based User
Database role
Database security objects' permissions
Database security objects' memberships
Database security objects' ownerships
Database assemblies
Asymmetric key
Certificate
Symmetric key

20. Schema

21. Full text catalog

22. Full text stop list

23. Search property list

24. Search property

25. Partition function

26. Partition scheme

27. Rule

28. Xml schema collection

29. User defined data type

30. CLR User defined type

31. Sequence

32. User defined table type

33. User defined aggregate

34. Stored procedure

35. Service broker

36. Message type

37. Service contract

38. Service queue

39. Broker service

40. Service route

41. Remote service binding

42. Broker priority

43. Synonym

44. Table, View, and UDF*
Scalar UDF
Regular table
User defined function
Table
Table View UDF

45. Clustered index

46. Table Data

47. Non-clustered index

48. Primary xml index

49. Secondary xml index

50. Spatial index

51. Full text index

52. Default constraint

53. Foreign key constraint

54. Check constraint

55. DML trigger

56. Statistic

57. Plan guide

58. Database audit specification

59. Database DDL Trigger

60. Extended property

61. Resource pool

62. Workload group

63. Resource governor

64. Mail

65. Mail profile

66. Mail account

67. Mail server

68. Configuration value

69. Job

70. Step,

71. Operator

72. Operator category

73. Job category

74. Alert category

75. Schedule

76. Target server group

77. Alert

78. Backup device

79. Proxy account

80. Job server

81. Alert system

82. Server audit specification

83. Server DDL Trigger

84. Unknown Type

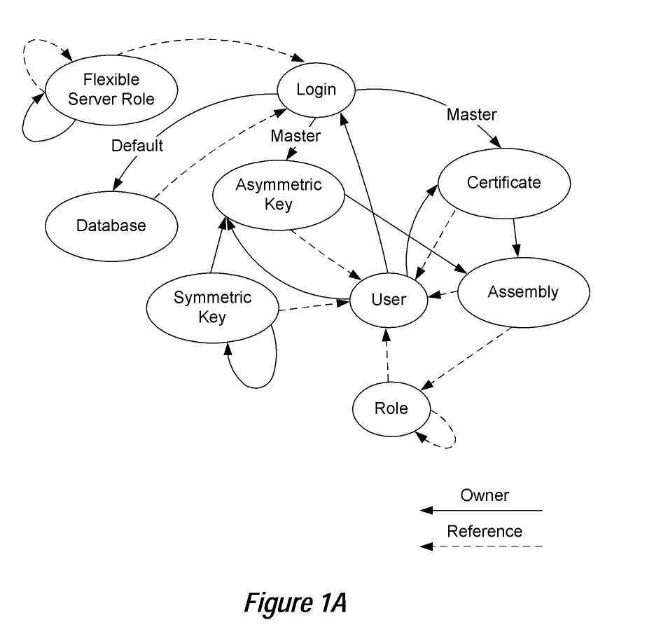

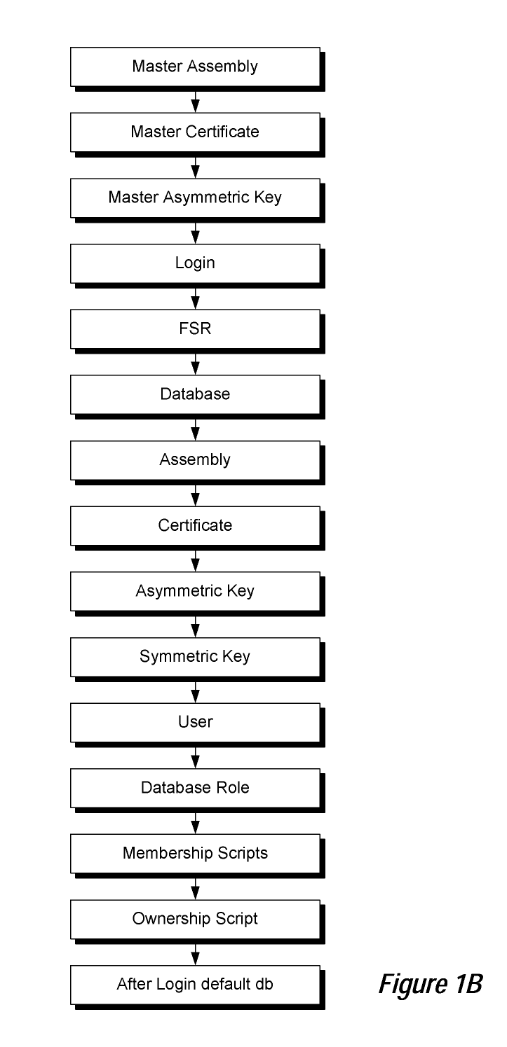

As shown above, server security objects and database security objects are two classifications of objects that have dynamic characteristics and thus are not strictly statically ordered. The following illustrates actions that may be performed with respect to server security objects and database security objects to facilitate static ordering. Referring now to FIG. 1A, an illustrative graphical representation of dependencies is shown. To solve the shown interdependencies, rather than having a have a single T-SQL script for an object with its relationship, the relationships can be expressed separately without being part of the object's creating script.

For example, if a role's create script and relationship are expressed in a single block, it may be expressed as:

CREATE ROLE [test] AUTHORIZATION [role1]
ALTER ROLE [test] ADD MEMBER [role2]
GRANT TAKE OWNERSHIP ON ROLE::[role3] TO [test]

In previous solutions, a script would be executed to find all dependencies like role1, role2, role3. Additional scripts would be run recursively to find their dependencies. In contrast, some embodiments herein split the relationships if possible. For example, embodiments may split an object from its relationships. For the single block illustrated above, this results in four separate parts:

Part 1: CREATE ROLE [test]
Part 2: ALTER ROLE [test] ADD MEMBER [role2]
Part 3: GRANT TAKE OWNERSHIP ON ROLE::[role3] TO [test]
Part 4: ALTER AUTHORIZATION ON ROLE::[test] TO [role1]

Splitting an object from its relationships may be done for all such similar objects shown in FIG. 1A. The parts (i.e. objects and relationships) are then ordered in an appropriate order. In particular, parts are ordered statically, such as for example in an order that is in an order like that of the ordered static list shown above. FIG. 1B illustrates an ordered graph for the object map shown in FIG. 1A.

In general, under the Sever Security Objects entry above in the execution ordered static list, is shown how the parts for server security objects are statically ordered. Similarly, under the Database Security Objects entry above in the execution ordered static list above, is shown how the parts for database security objects are statically ordered.

As shown in the execution ordered static list above, another non-static interdependent type group is of Table, View and User Defined Functions.

A table can contain a computed column which is depending on scalar userdefined function. For example, consider the following block with the user defined function dbo.func(a):

```
CREATE TABLE [dbo].[table_name](
    [a] [int] NULL,
    [b] AS (dbo.func(a))
)
```

This function can depend on a view which in turn can depend on some table. Due to the dependencies, a simply type based static ordering cannot be done. Rather, embodiments may first separate hard dependencies from soft dependencies. Soft dependencies have more flexibility in their application than hard dependencies. Thus for example, if a function is not schema-bound or inline its dependencies are soft and embodiments can put them first in a static ordering so that other objects which have hard dependencies on them do not have ordering problems.

Similarly a table without computed columns does not have dependencies on UDF, View or Table so embodiments can order them first. Then embodiments can add tables with computed columns whose dependencies have already been added next.

What remains are tables, views and functions with hard dependencies. These are ordered on a per object basis among themselves. These may be ordered by sending a query to an sql server. Alternatively, embodiments may use an offline parser to find dependencies. The process is complete if objects can be ordered on the basis of individual dependencies. If objects cannot be ordered on the basis of individual dependencies, a cyclic dependency remains and an error can be reported. However, some embodiments can solve even these cyclic dependencies by methods such as splitting computed columns and having two definitions: one for create and one for alter etc.

A summarized representation for the process for Tables, Views, and UDF is illustrated above under the entry for Table, View, and UDF in the execution ordered static list illustrated above.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

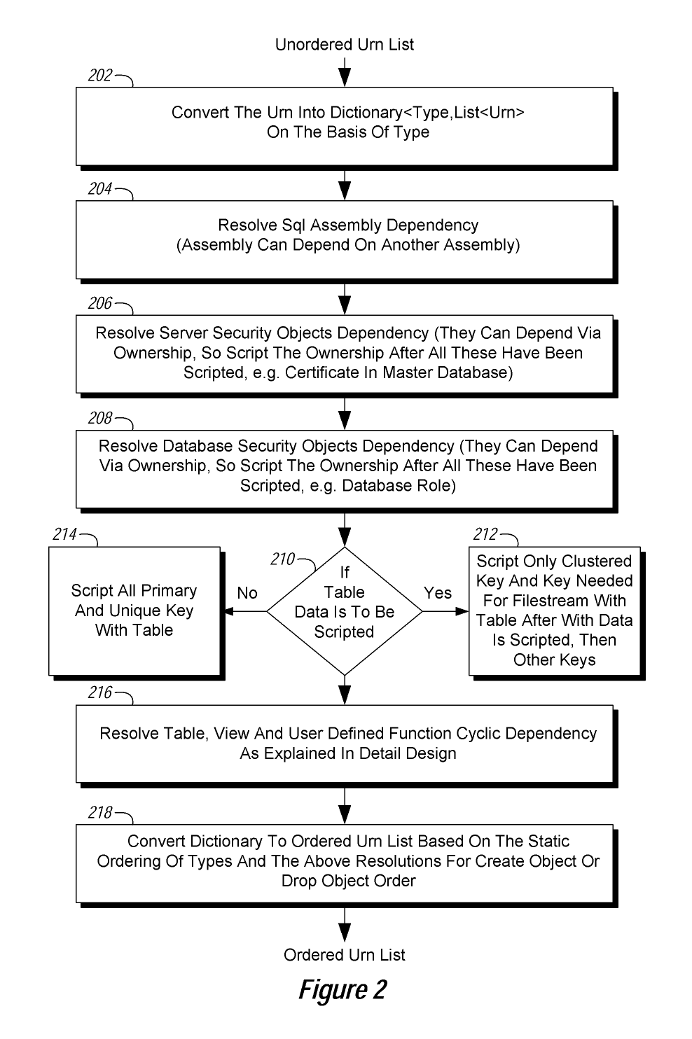

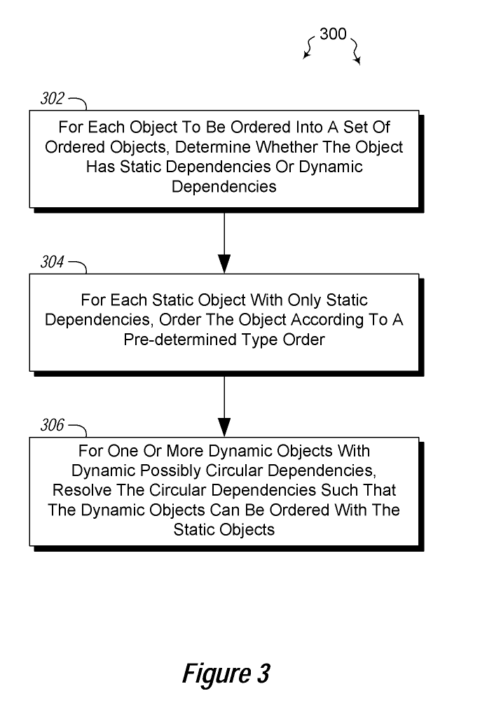

Referring now to FIG. 2, an overall method taking into account static and dynamic dependencies is illustrated. FIG. 2, as will be demonstrated, includes provisions for dynamic objects, such as server security objects, database security objects, and tables, views and UDFs as illustrated in the execution ordered static list illustrated above as well as static objects as illustrated in the execution ordered static list illustrated above.

FIG. 2 illustrates converting an urn list into a dictionary on the basis of type (act 202). FIG. 2 further illustrates resolving sql assembly dependencies (act 204). An assembly may depend on another assembly. FIG. 2 further illustrates resolving server security object dependencies (act 206) FIG. 2 further illustrates resolving database security object dependencies (act 208). FIG. 2 further illustrates that a determination is made as to whether table data is to be scripted (decision 210). If so, then only clustered keys and keys needed for a filestream with a table are scripted, after which data is scripted, followed by other keys (act 212). If not, all primary and unique keys are scripted with a table (act 214). FIG. 2 further illustrates resolving cyclic dependencies for tables, views and user defined functions (act 216). FIG. 2 further illustrates converting the dictionary to an ordered urn list based on the static ordering of types and previous resolutions for creating or dropping object order.

Referring now to FIG. 3, a method 300 is illustrated. The method my be practiced in a computing environment, and includes acts for ordering data objects. The method includes for each object to be ordered into a set of ordered objects, determining whether the object has static dependencies or dynamic dependencies (act 302). A dynamic object is an object that may have circular dependencies.

The method may further include for each static object with only static dependencies, ordering the object according to a pre-determined type order (act 304). For one or more dynamic objects with dynamic possibly circular dependencies, the method includes resolving the circular dependencies such that the dynamic objects can be ordered with the static objects (act 306).

Various methodologies may exist for resolving circular dependencies. For example, in some embodiments, resolving the circular dependencies includes stripping out ownership of a dynamic type to create a static type. In another example, resolving the circular dependencies includes splitting an object from its dependencies. In another example, resolving the circular dependencies includes separating hard dependencies from soft dependencies. In another example, resolving the circular dependencies includes sending a query to an sql server. In another example, resolving the circular dependencies includes using an offline parser to find dependencies.

Once data objects have been ordered, they may be migrated to a different system or location. Thus, in some embodiments, the method 300 further includes migrating the ordered objects after they have been ordered.

Objects may be ordered according to a pre-determined order based on pre-determined type. In some embodiments, the pre-determined type order specifies ordering for Assemblies, Data Types, Stored Procedure, and Triggers. Further embodiments may be implemented where the pre-determined type order specifies that Assemblies are ordered at the beginning of an ordering. Embodiments may be implemented where the pre-determined type order specifies that Triggers are at the end of an ordering. Embodiments may be implemented where the pre-determined type order specifies ordering Stored Procedure before Data Types as Data Types always depend from Stored Procedures.

Dynamic objects may be identified by their type. For example, embodiments may be implemented where one or more of the dynamic objects may be determined to be a dynamic object based on the object being a server security object. One or more of the dynamic objects is determined to be a dynamic object based on the object being a database security object. One or more of the dynamic objects may be determined to be a dynamic object based on the object being at least one of a table, view, or user defined function.

Embodiments may also include error handling functionality. For example, the method 300 may further include determining that an object cannot be ordered on the basis of individual dependencies and as a result, reporting an error.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of ordering data objects, the method comprising:
for each object to be ordered into a set of ordered objects, determining whether the object has static dependencies or dynamic dependencies, wherein a dynamic object is an object that may have circular dependencies;
for each static object with only static dependencies, ordering the object according to a pre-determined type order; and
for one or more dynamic objects with dynamic possibly circular dependencies, resolving the circular dependencies such that the dynamic objects can be ordered with the static objects.

2. The method of claim 1, wherein resolving the circular dependencies comprises stripping out ownership of a dynamic type to create a static type.

3. The method of claim 1, wherein resolving the circular dependencies comprises splitting an object from its dependencies.

4. The method of claim 1, wherein resolving the circular dependencies comprises separating hard dependencies from soft dependencies.

5. The method of claim 1, wherein resolving the circular dependencies comprises sending a query to an sql server.

6. The method of claim 1, wherein resolving the circular dependencies comprises using an offline parser to find dependencies.

7. The method of claim 1 further comprising, migrating the ordered objects after they have been ordered.

8. The method of claim 1, wherein the pre-determined type order specifies ordering for Assemblies, Data Types, Stored Procedure, and Triggers.

9. The method of claim 1, wherein the pre-determined type order specifies that Assemblies are ordered at the beginning of an ordering.

10. The method of claim 1, wherein the pre-determined type order specifies that Triggers are at the end of an ordering.

11. The method of claim 1, wherein the pre-determined type order specifies ordering Stored Procedure before Data Types as Data Types always depend from Stored Procedures.

12. The method of claim 1, wherein one or more of the dynamic objects is determined to be a dynamic object based on the object being a server security object.

13. The method of claim 1, wherein one or more of the dynamic objects is determined to be a dynamic object based on the object being a database security object.

14. The method of claim 1, wherein one or more of the dynamic objects is determined to be a dynamic object based on the object being at least one of a table, view, or user defined function.

15. The method of claim 1 further comprising, determining that an object cannot be ordered on the basis of individual dependencies and as a result, reporting an error.

16. In a computing environment, a computer readable medium comprising computer executable instructions that when executed by one or more processors perform the following:
for each object to be ordered into a set of ordered objects, determining whether the object has static dependencies or dynamic dependencies, wherein a dynamic object is an object that may have circular dependencies;
for each static object with only static dependencies, ordering the object according to a pre-determined type order; and
for one or more dynamic objects with dynamic possibly circular dependencies, resolving the circular dependencies such that the dynamic objects can be ordered with the static objects.

17. The computer readable medium of claim 16, wherein resolving the circular dependencies comprises stripping out ownership of a dynamic type to create a static type.

18. The computer readable medium of claim 16, wherein resolving the circular dependencies comprises splitting an object from its dependencies.

19. In a computing environment, a computing system comprising:
one or more physical computer readable media;
one or more processors coupled to the one or more physical computer readable media;
computer executable instructions stored on the one or more physical computer readable media that when executed by one or more of the one or more processors perform the following:
for each object to be ordered into a set of ordered objects, determining whether the object has static dependencies or dynamic dependencies, wherein a dynamic object is an object that may have circular dependencies;
for each static object with only static dependencies, ordering the object according to a pre-determined type order; and
for one or more dynamic objects with dynamic possibly circular dependencies, resolving the circular dependencies such that the dynamic objects can be ordered with the static objects.

20. The system of claim 19, wherein resolving the circular dependencies comprises stripping out ownership of a dynamic type to create a static type.
